(19) United States
(12) Patent Application Publication
(10) Pub. No.: US 2004/0175010 A1
(43) Pub. Date: Sep. 9, 2004

(54) Method for frequency transposition in a hearing device and a hearing device

(76) Inventors: Silvia Allegro, Oetwil am See (CH); Olegs Timms, Zurich (CH)

Correspondence Address: PEARNE & GORDON LLP, 1801 EAST 9TH STREET, SUITE 1200, CLEVELAND, OH, 44114-3108, US

(21) Appl. No.: 10/383,142

(22) Filed: Mar. 6, 2003

(51) Int. Cl. H04R 25/00

(52) U.S. Cl. 381/316; 381/312

(57) ABSTRACT

The present invention is related to a method for frequency transposition in a hearing device by transforming an acoustical signal into an electrical signal (s) and by transforming the electrical signal from time domain into frequency domain to obtain a spectrum (S). According the present invention, a frequency transposition is being applied to the spectrum (S) in order to obtain a transposed spectrum (S′), whereby the frequency transposition is being defined by a nonlinear frequency transposition function, Thereby, it is possible to transpose lower frequencies almost linearly, while higher frequencies are transposed more strongly. As a result thereof, harmonic relationships are not distorted in the lower frequency range, and at the same time, higher frequencies can be moved into a lower frequency range, namely in an audible range of the hearing impaired. The transposition scheme can be applied to the complete signal spectrum without the need for switching between non-transposition and transposition processing for different parts of the signal. Therefore, no artifacts due to switching are encountered when applying the present invention.

The present invention relates to a method for frequency transposition in a hearing device according to the pre-characterizing part of claim 1, to a hearing device according to the pre-characterizing part of claim 7 as well as to a use of the method for a binaural hearing device.

Numerous frequency-transposition schemes for the presentation of audio signals via hearing devices for people with a hearing impairment have been developed and evaluated over many years. In each case, the principal aim of the transposition is to improve the audibility and discriminability of signals in a particular frequency range by modifying those signals and presenting them at other frequencies. Usually, high frequencies are transposed to lower frequencies where hearing device users typically have better hearing ability. However, various problems have limited the successful application of such techniques in the past. These problems include technological limitations, distortions introduced into the sound signals by the processing schemes employed, and the absence of methods for identifying suitable candidates and for fitting frequency-transposing hearing aids to them using appropriate objective rules.

The many techniques for frequency transposition reported previously can be subdivided into three broad types: frequency shifting, frequency compression, and reducing the playback speed of recorded audio signals while discarding portions of the signal in order to preserve the original duration.

Among frequency compression schemes, many linear and non-linear techniques including FFT/IFFT processing, vocoding, and high-frequency envelope transposition followed by mixing with unmodified low-frequency components have been investigated. Since harmonic patterns and formant relations are known to be important in the accurate perception of speech, it is also helpful to distinguish spectrum-preserving techniques from spectrum-destroying techniques. Each of these techniques is summarized briefly below.

At present, the only frequency-transposing hearing instruments available commercially are those manufactured by AVR Ltd., a company based in Israel and Minnesota, USA (see http://www.avrsono.com). An instrument produced previously by AVR, known as the TranSonic, has been superseded recently by the ImpaCt and Logicom-20 devices. All of these frequency-transposition instruments are based on the selective reduction of the playback speed of recorded audio signals. This is achieved by first sampling the input sound signal at a particular rate., and then storing it in a memory. When the recorded signal is subsequently read out of the memory, the sampling rate is reduced when frequency-lowering is required. Because the sampling rate can be changed, it is possible to apply frequency lowering selectively. For example, different amounts of frequency-lowering can be applied to voiced and unvoiced speech components. The presence of each type of component in the input signal is determined by estimating the spectral shape: the signal is assumed to be unvoiced when a spectral peak is detected at frequencies above 2.5 kHz, voiced otherwise. In order to maintain the original duration of the signals, parts of the sampled data in the memory are discarded when necessary. U.S. Pat. No. 5,014,319 assigned to AVR describes not only the compression of input frequencies (i.e. frequencies are transposed into lower ranges) but also frequency expansion (i.e. transposition into higher frequency ranges). Other similar methods of frequency transposition by means of reducing the playback speed of recorded audio signals have also been reported previously (e.g. FR-2 364 520, DE-17 62 185). As mentioned, a major problem with any of these schemes is that portions of the input signal must be discarded when the playback speed is reduced (to compress frequencies) in order to maintain the original signal duration, which is essential in a real-time assistive listening system such as a hearing device. This could result in audible distortions in the output signal and in some important sound information being inaudible to the hearing device user.

Linear frequency compression by means of Fourier Transform processing has been investigated by Turner and Hurtig at the University of Iowa, USA (Turner, C. W. and R. R. Hurtig: “Proportional Frequency Compression of Speech for Listeners with Sensorineural Hearing Loss”, Journal of the Acoustical Society of America, vol. 106(2), pp. 877-886, 1999), and has led to an international patent application having the publication number WO 99/14 986. This real-time algorithm is based on the Fast Fourier Transform (FFT). Input signals are converted into the frequency domain by an FFT having a relatively large number of frequency bins. To achieve frequency lowering, the reported-algorithm multiplies each frequency bin by a constant factor (less than 1) to produce the desired output signal in the frequency domain. Data loss resulting from this compression of the spectrum is minimized by linear interpolation across frequencies. The output signal is then converted back into the time domain by means of an inverse FFT (IFFT). One disadvantage of this technique is that it is very inefficient computationally, and would consume an unacceptably large amount of electrical energy if implemented in a hearing device. Furthermore, it is possible that the propagation delay of signals processed by this algorithm would be unacceptably long for hearing device users, potentially resulting in some interference with their lip-reading ability.

A feature extraction and signal resynthesis procedure and system based on a vocoder have been described by Thomson CSF, Paris in EP-1 006 511. Information about pitch, voicing, energy, and spectral shape is extracted from the input signal. These features are modified (e.g. by compressing the formant frequencies in the frequency domain) and then used for synthesis of the output signal by means of a vocoder (i.e. a relatively efficient electronic or computational device or technique for synthesizing speech signals). A very similar approach has also been described by Strong and Palmer in U.S. Pat. No. 4,051,331. Their signal synthesis is also based on modified speech features. However, it synthesizes voiced components using tones, and unvoiced components using narrow-band noises. Thus, these techniques are spectrum-destroying rather than spectrum-preserving.

A phase vocoder system for frequency transposition is described in a paper by H. J. McDermott and M. R. Dean (“Speech perception with steeply sloping hearing loss”, British Journal of Audiology, vol 34, pp 353-361, December 2000). A non-real-time implementation is disclosed using a computer program. Digitally recorded speech signals were low pass filtered, down sampled and windowed, and then processed by a FFT. The phase values from successive FFTs were used to estimate a more precise frequency for each FFT bin, which was used to tune an oscillator corresponding to each FFT bin. Frequency lowering was achieved by multiplying the frequency estimates for each FFT-bin by a constant factor.

Another system that can separately compress the frequency range of voiced and unvoiced speech components as well as the fundamental frequency has been described by S. Sakamoto, K. Goto, et. al. (“Frequency Compression Hearing Aid for Severe-To-Profound Hearing Impairments”, Auris Nasus Larynx, vol. 27, pp. 327-334, 2000). This system allows independent adjustment of the frequency compression ratio for unvoiced and voiced speech, fundamental frequency, the spectral envelope, and the instrument's frequency response by the selection of different filters. The compression ratio for either voiced or unvoiced speech is adjustable from 10% to 90% in steps of 10%. The fundamental frequency can either be left unmodified, or compressed with a compression factor either the same as, or lower than, that employed for voiced speech. A problem with each of the above feature-extraction and resynthesis processing schemes is that it is technically extremely difficult to obtain reliable estimates of speech features (such as fundamental frequency and voicing) in a wearable, real-time hearing instrument, especially in unfavorable listening conditions such as when noise or reverberation is present.

EP-0 054 450 describes the transposition and amplification of two or three different bands of the frequency spectrum into lower-frequency bands within the audible range. In this scheme, the number of “image” bands equals the number of original bands. The frequency compression ratio can be different across bands, but is constant within each band. The image bands are arranged contiguously, and transposed to frequencies above 500 Hz. In order to free this part of the spectrum for the image bands, the amplification for frequencies between 500 and 1000 Hz decreases gradually with increasing frequency. Frequencies below 500 Hz in the original signal are amplified with a constant gain.

In U.S. Pat. No. 4,419,544 to Adelman, the input signal is subjected to adaptive noise canceling before filtering into at least two pass-bands takes place. Frequency compression is then carried out in at least one frequency band.

Other techniques described previously include the modulation of tones or noise bands in the low-frequency range based on the energy present in higher frequencies (e.g. FR-1 309 425, U.S. Pat. No. 3,385,937), and various types of linear and non-linear transposition of high-frequency components which are then superimposed onto the low-frequency part of the spectrum (e.g. U.S. Pat. No. 5,077,800 and U.S. Pat. No. 3,819,875). Another approach (WO 00/75 920) describes the superposition of the original input signal with several frequency-compressed and frequency-expanded versions of the same signal to generate an output signal containing several different pitches, which is claimed to improve the perception of sounds by hearing-impaired listeners.

Problems with each of the above described methods for frequency transposition include technical complexity, distortion or loss of information about sounds in some circumstances, and unreliability of the processing in difficult listening conditions, e.g. in the presence of background noise.

It is therefore an object of the present invention to enable frequency transposition to be carried out more efficiently in a hearing device.

This object is achieved, for a method for frequency transposition in hearing devices, by the elements of the characterizing part of claim 1. Further achievements of the method according to the present invention, a hearing device as well as a use of the method are subject to further claims.

By applying a frequency transposition to the spectrum of the acoustic signal to obtain a transposed spectrum, whereby the frequency transposition is being defined by a nonlinear frequency transposition function, it is possible to transpose lower frequencies almost linearly, while higher frequencies are transposed more strongly. As a result thereof, harmonic relationships are not distorted in the lower frequency range, and at the same time, higher frequencies can be moved into a lower frequency range, namely in an audible range of the hearing impaired. The transposition scheme can be applied to the complete signal spectrum without the need for switching between non-transposition and transposition processing for different parts of the signal. Therefore, no artifacts due to switching are encountered when applying the present invention.

The present invention is further explained by referring to an exemplified embodiment shown in drawings. It is shown in

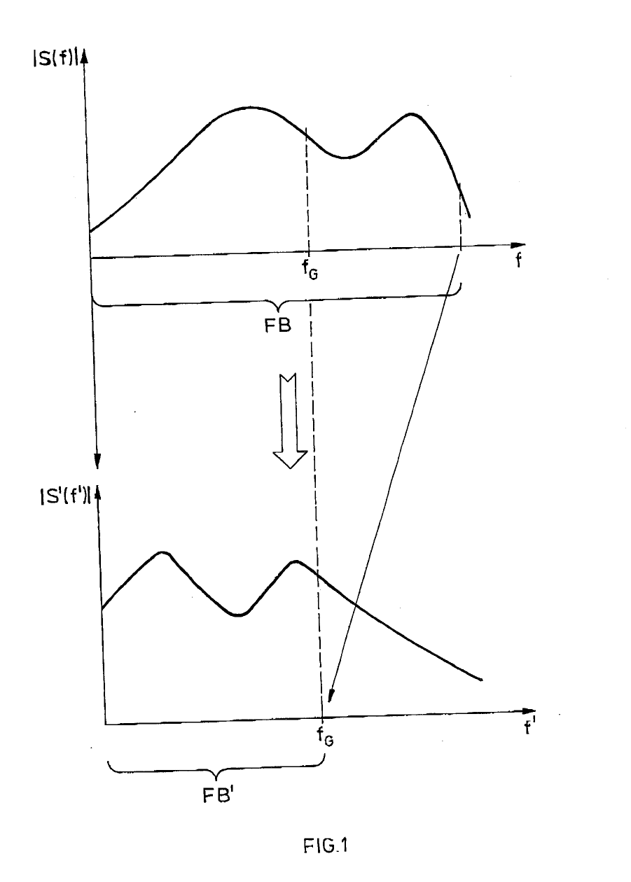

FIG. 1 a magnitude as a function of frequency of an acoustic signal as well as the transposed magnitude as a function of frequency of that signal;

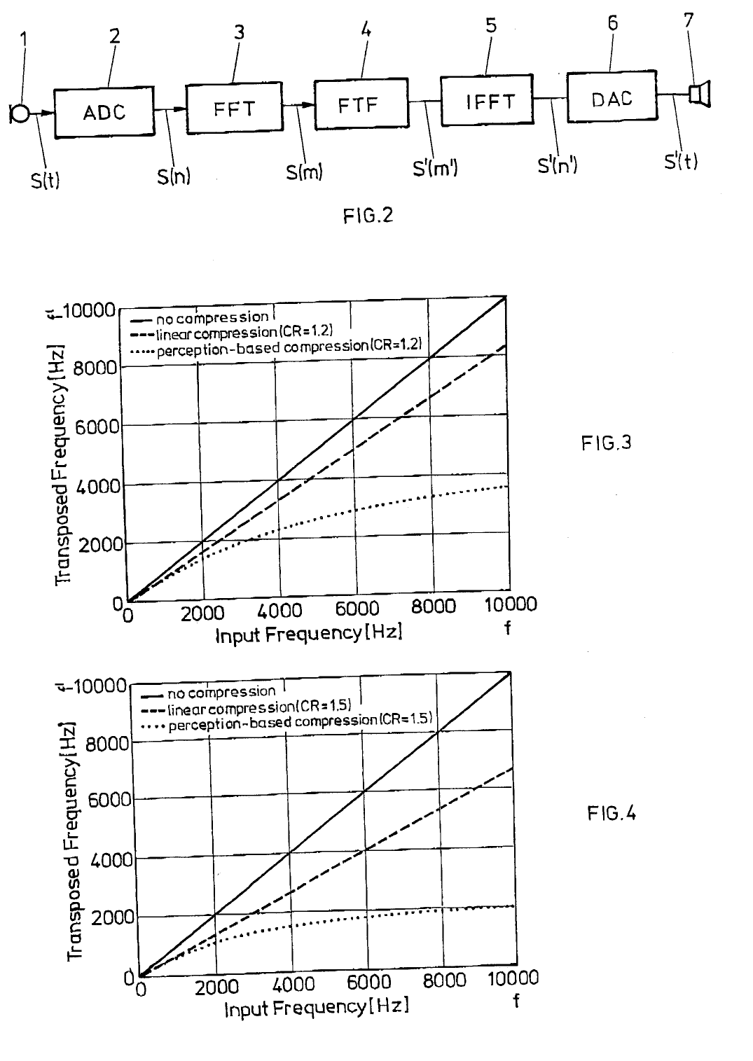

FIG. 2 a block diagram of a hearing device according to the present invention;

FIGS. 3 and 4 frequency transposition schemes having no compression, linear compression and perception-based compression.

As has already been mentioned, frequency transposition is a potential means for providing profoundly hearing impaired patients with signals in their residual range. The process of frequency transposition is illustrated in FIG. 1, wherein the magnitude spectrum |S(f)| is shown of an acoustic signal in the upper graph of FIG. 1. A frequency band FB is transposed by a frequency transposition function to obtain a transposed magnitude spectrum |S′(f)| and a transposed frequency band FB′. It is assessed that the hearing ability of the patient is more or less intact in the transposed frequency band FB′ whereas in the frequency band FB it is not. Therefore, it is possible by the frequency transposition to image a part of the spectrum from an inaudible to an audible range of the patient.

So far, linear frequency transposition (as it is shown in FIGS. 3 and 4 by the dashed line), or linear frequency transposition applied to only parts of the spectrum of a acoustic signal, is the only meaningful scheme since all nonlinear frequency transposition methods of the state of the art distort the signal in such a manner that potential subjects reject the processing. The application of linear frequency transposition is however limited in that in order to preserve a reasonable intelligibility of the speech signal, the frequency span of the compressed signal should not be less that 60 to 70% of the original bandwidth. This conclusion has been found by C. W. Turner and R. R. Hurtig in the paper entitled “Proportional Frequency Compression of Speech for Listeners with Sensorineural Hearing Loss” (Journal of the Acoustical Society of America, 106(2), pp. 877-886, 1999). The compression factors are thus limited to values in the range of up to 1.5.

With the above-described limitation, common consonant frequencies lying in the range of 3 to 8 kHz can only be compressed into approximately 2 to 5 kHz. For most hearing impaired patients, however, these frequencies are still poorly audible or inaudible at all. The desired benefit of frequency transposition can thus not be achieved.

Nonlinear transposition schemes were not considered so far because the distortion of the harmonic relationship in lower frequencies has a detrimental effect on vowel recognition and is therefore totally unacceptable.

The possibility to overcome the above-mentioned problems has been documented by Sakamoto et. al. (see above): Voiced and unvoiced components of the signal have been distinguished, and the frequency transposition has only been applied to the unvoiced components. Although nonlinear transposition might be suitable in this case because the important low frequent harmonic relationships are not transposed and therefore unchanged, switching between different processing schemes creates audible artifacts as well, and is therefore also disadvantageous.

FIG. 2 shows a simplified block diagram of a digital hearing device according to the present invention comprising a microphone 1, an analog-to-digital converter unit 2, a transformation unit 3, a signal processing unit 4, an inverse transformation unit 5, a digital-to-analog converter unit 5 and a loudspeaker 7, also called receiver. Of course, the invention is not only suitable for implementation in a digital hearing device but can also readily be implemented in an analog hearing device. In the latter case, the analog-to-digital converter unit 2 and the digital-to-analog converter unit 6 are not necessary.

In a further embodiment of the present invention, instead of the inverse transformation unit 5 a so called VOCODER is used in which the output signal is synthesized. For further information regarding the functioning of a VOCODER, reference is made to H. J. McDermott and M. R. Dean (“Speech perception with steeply sloping hearing loss”, British Journal of Audiology, vol 34, pp 353-361, December 2000).

Furthermore, an implementation of the invention is not only limited to conventional hearing devices, such as BTE—(behind the ear), CIC—(completely in the canal) or ITE—(in the ear) hearing devices. An implementation in implantable devices is also possible. For implantable devices, a transducer is used instead of the loudspeaker 7 which transducer is either operationally connected to the signal processing unit 4, or to the inverse transformation unit 5, or to the digital-to-analog converter unit 6, and which transducer is made for direct transmitting acoustical information to the middle or inner ear of the patient.

In the transformation unit 3, the sampled acoustic signal s(n) is transformed into the frequency domain by an appropriate frequency transformation function in order to obtain the discrete spectrum S(m). In a preferred embodiment of the present invention, a Fast Fourier Transformation is applied in the transformation unit 3. In this connection, reference is made to the publication of Alan V. Oppenheim and Ronald W. Schafer “Discrete-time Signal Processing” (Printice-Hall Inc., 1989, chapters 8 to 11).

In the signal processing unit 4, a frequency transposition is being applied to the spectrum S(m) in order to obtain a transposed spectrum S′(m′), whereby the frequency transposition is being defined by a nonlinear frequency transposition function.

In a preferred embodiment of the present invention, the nonlinear frequency transposition function has a perception-based scale, such as the Bark, ERB or SPINC scale. Regarding Bark, reference is made to E. Zwicker and H. Fastl in “Psychoacoustics—Facts and Models” (2nd edition, Springer, 1999), regarding ERB, reference is made to B. C. J. Moore and B. R. Glasberg in “Suggested formulae for calculating auditory-filter bandwidths and excitation patterns” (J. Acoust. Soc. Am., Vol. 74, no. 3, pp. 750-753, 1983), and regarding SPINC, reference is made to Ernst Terhardt in “The SPINC function for scaling of frequency in auditory models” (Acustika, no. 77, 1992, p. 40-42). With these frequency transposition functions, lower frequencies are transposed almost linearly, while higher frequencies are transposed more strongly. Hence, harmonic relationships are not distorted in the lower frequency range, and, at the same time, higher frequencies can be moved into such low frequencies that they can fall into the audible range of profoundly haring impaired. The frequency transposition function can be applied to the complete signal spectrum, without the need for switching between non-transposition and transposition processing for different parts of the signal.

FIGS. 3 and 4 show different frequency transposition functions and transposition factors, wherein the horizontal axis represents the input frequency f and the vertical axis represents the corresponding output frequency f′. The graphs drawn by a dotted line represent different frequency transposition functions according to the present invention. The graphs drawn by solid and dashed lines are for comparison and show corresponding state of the art frequency transposition functions.

In FIG. 3, three different transposition schemes are represented in the same graph:

solid line: no compression, therefore no frequency transposition;

dashed line: linear compression with compression rate CR=1.2;

dotted line: perception-based compression with compression rate CR=1.2.

In FIG. 4, again three different transposition schemes are represented in the same graph with the following characteristics:

solid line: no compression, therefore no frequency transposition (same as in FIG. 3);

dashed line: linear compression with compression rate CR=1.5;

dotted line: perception-based compression with compression rate CR=1.5.

In a preferred embodiment of the present invention, the SPINC—(spectral pitch increment) compression scheme is implemented by transforming the input frequency f into the SPINC scale Φ applying the desired compression factor CR in the SPINC scale, and transforming back to the linear frequency scale. Therefore, the corresponding frequency transposition function can be defined as follows:

$${f}^{′} = const \cdot tan ( \frac{{Φ}^{′} ( f )}{const} ) ,$$

wherein

$${Φ}^{′} ( f ) = \frac{Φ ( f )}{CR}$$

$$and$$

$$Φ ( f ) = const \cdot arctan ( \frac{f}{const} )$$

and

const=1000·\sqrt{2}.

It goes without saying that similar frequency compression can also be achieved in other perception-based frequency transpositions such as by using the Bark or the ERB scale.

In a further embodiment, the frequency transposition function is stored in a look-up table which is provided in the signal processing unit 4, or which look-up table can be easily accessed by the signal processing unit 4.

1. Method for frequency transposition in a hearing device by
transforming an acoustical signal into an electrical signal (s) and
transforming the electrical signal (s) from time domain into frequency domain to obtain a spectrum (S),
characterized in that
a frequency transposition is being applied to the spectrum (S) in order to obtain a transposed spectrum (S′),
whereby the frequency transposition is being defined by a nonlinear frequency transposition function.

2. Method according to claim 1, characterized in that the nonlinear frequency transposition function is perception-based.

3. Method according to claim 1 or 2, characterized in that the nonlinear frequency transposition function is a continuous function.

4. Method according to claim 2 or 3, characterized in that the perception-based frequency transposition function is being defined by one of the following functions:
Bark function;
ERB function; or
SPINC function.

5. Method according to one of the claims 1 to 4, characterized in that the frequency transposition function is being defined in a look-up table.

6. Method according to one of the claims 1 to 5, characterized in that the transposed spectrum (S′) is being applied to an output transducer (7).

7. Hearing device comprising
at least one microphone (1),
a transformation unit (3) and
a signal processing unit (4),
whereas the transformation unit (3) is operationally connected to the at least one microphone (1) and to the signal processing unit (4),
characterized in that a nonlinear transposition function is applied in the signal processing unit (4).

8. Hearing device according to claim 7, characterized in that the nonlinear frequency transposition function is perception-based.

9. Hearing device according to claim 7 or 8, characterized in that the nonlinear frequency transposition function is a continuous function.

10. Hearing device according to claim 8 or 9, characterized in that the perception-based frequency transposition function is defined by one of the following functions:
Bark function; or
ERB function; or
SPINC function.

11. Hearing device according to one of the claims 7 to 10, characterized in that a look-up table is provided in which the frequency transposition function is defined, the look-up table being either operationally connected to the signal processing unit (4) or being integrated into the signal processing unit (4).

12. Hearing device according to one of the claims 7 to 11, characterized in that at least one output transducer (7) is operationally connected to the signal processing unit (4).

13. Hearing device according to one of the claims 7 to 11, characterized in that an inverse transformation unit (5) or any other synthesizing means are operationally connected to the signal processing unit (4).

14. Hearing device according to claim 13, characterized in that at least one output transducer (7) is operationally connected to the inverse transformation unit (5) or to the other synthesizing means.

15. Use of the method according to one of the claims 1 to 6 for a binaural hearing device.
